(19) United States
(12) Patent Application Publication
(10) Pub. No.: US 2014/0229331 A1
(43) Pub. Date: Aug. 14, 2014

(54) EMBEDDED PURCHASING SYSTEM AND METHOD

(71) Applicant: FORA.tv, Inc., San Francisco, CA (US)

(72) Inventors: Michael McIntosh, Oakland, CA (US); Allan Claghorn, San Francisco, CA (US)

(73) Assignee: FORA.tv, Inc., San Francisco, CA (US)

(21) Appl. No.: 14/172,853

(22) Filed: Feb. 4, 2014

Related U.S. Application Data
(60) Provisional application No. 61/763,257, filed on Feb. 11, 2013.

(51) Int. Cl. G06Q 30/06

(52) U.S. Cl. CPC G06Q 30/0633; G06Q 30/0613
USPC 705/26.41

(57) ABSTRACT

An online retailer may post content to a third-party web site to offer content items for sale. A user may view or preview the posted content items, and may select an item to purchase. Payment for the item may be initiated independently of any interaction of the user with a web site hosted by the online retailer. An account with the online retailer may automatically be created and credited with the purchase; alternatively, the purchase can be credited to a previously established account. The payment may be processed via an online payment processor independent of the online retailer and the third party. The item may be a digital streaming video or any other suitable type of content item. After the payment is processed, the user's computer may be authorized to permit playback through the third-party web site or on a web site hosted by the online retailer.

### CROSS-REFERENCE TO RELATED APPLICATION

The present application claims priority from U.S. Provisional Application Ser. No. 61/763,257 for “Point-of-Purchase Player,” Attorney Docket No. FOR001-PROV, filed Feb. 11, 2013, which is incorporated by reference herein in its entirety.

### FIELD OF THE INVENTION

The present invention relates to systems and methods for making purchases online, and more particularly, embedding point-of-purchase functionality in a web site.

### DESCRIPTION OF THE RELATED ART

Online shopping has become the method of choice for many people to purchase items ranging from books to vehicles. Typically, online shopping is done through online retailers with dedicated retail sites such as amazon.com that have built-in transactional functionality. Such sites often receive traffic through advertisements and other links posted on third-party web sites. A user browsing the third-party web site may then click on the ad or link, which takes the user to the online retailer's web site, where the user can complete a purchase.

Unfortunately, this model has a number of drawbacks. First of all, navigation away from the third-party web site may not be desirable for the host of the third-party web site, who may want to retain as much traffic and viewing time as possible on the third-party web site. Thus, third-party web sites may be reluctant to post the ads or links desired by online retailers. Even if the online retail web site opens in another tab or browser window to keep the third-party web site open, the user's attention has been lost, and the user may or may not return to the third-party web site once the purchase is made.

Secondly, navigation away from the third-party web site may disrupt the browsing activities of the user. A user who encounters an advertisement or a link on the third-party web site is often in pursuit of information other than the goods and services that are being advertised. Thus, the user may not want to disrupt his or her “train of thought” to visit the e-commerce site in the midst of other browsing activities.

Third, navigation to the online retailer's web site may take too much time for the user. This may be particularly the case when the product for sale is digital media, such as digital video, pictures, music, or the like. The chief attraction behind an online streaming format for media may be its immediate availability; any steps that detract from this immediate availability can cause the user to lose interest.

This problem may be exacerbated by the need for the user to create a new account with the online retailer. The account creation procedure requires additional time and energy, which further increases the likelihood that the user will lose interest before completing the purchase. Aside from the time requirements, the effort to manage a large number of login credentials can be onerous for the user, and he or she may not want to add one more to the list.

Accordingly, there exists a need for systems and methods for making online purchases that remedy the deficiencies present in known online navigation and purchasing systems.

### SUMMARY

According to various embodiments, an embeddable online widget may implement a point-of-purchase system by which an online retailer can sell items through a third-party web site. The items may be tangible goods or intangibles such as digital media. For example, such an embeddable online widget may include a media player for presenting video content. The videos may also be made available on a dedicated web site. Whether played through the embedded media player or the third-party web site, the videos may be playable on a wide variety of devices including computers, smart phones, and tablets with various operating systems.

The video player may provide free previews of videos. An online payment processor may be used to process payment for the full version of a purchased video. The online payment processor may provide information regarding the purchase to the online retailer; if the user does not already have an account with the online retailer, a new user account may be automatically created with credit for the purchased item(s). The automatically created account may then be used to enable playback of purchased digital content on other devices. If the user already has an account, the new account may be merged with the previously-established account, either automatically or at the election of the user.

In at least one embodiment, the presence of an existing account is detected by determining whether the user is using an email address (or other identifier) affiliated with an existing account; if so, the new purchase is associated with that existing account. If the user is using a different email address (or other identifier) causing a new account to be created, the user can subsequently indicate as such, so as to properly associate the purchase with the previously existing account rather than with the new account. The new account can then be deleted if desired.

In various embodiments, the point-of-purchase media player may facilitate the sale of single on-demand videos, multiple on-demand videos, a collection of on-demand videos organized as a complete conference or event, and/or live streams from conferences or other events. The point-of-purchase media player may also facilitate the sale of other types of content, such as for example audio files, transcripts, and/or the like.

Further details and variations are described herein.

### BRIEF DESCRIPTION OF THE DRAWINGS

The accompanying drawings illustrate several embodiments of the invention. Together with the description, they serve to explain the principles of the invention according to the embodiments. One skilled in the art will recognize that the particular embodiments illustrated in the drawings are merely exemplary, and are not intended to limit the scope of the present invention.

FIG. 1A is a block diagram depicting a hardware architecture for practicing the present invention according to one embodiment of the present invention.

FIG. 1B is a block diagram depicting a hardware architecture for practicing the present invention in a client/server environment, according to one embodiment of the present invention.

FIG. 2 is a block diagram depicting the structure of an online purchasing system according to one embodiment of the present invention.

FIG. 3 is a flowchart depicting a method of carrying out online purchasing according to one embodiment of the present invention.

FIG. 4 is a flowchart depicting the content display step of the method of FIG. 3 in greater detail, according to one embodiment of the invention.

FIG. 5 is a flowchart depicting the payment processing step of the method of FIG. 3 in greater detail, according to one embodiment of the invention.

FIG. 6 is a flowchart depicting the payment confirmation step of the method of FIG. 3 in greater detail, according to one embodiment of the invention.

FIG. 7 is screen shot depicting an initial view of a point-of-purchase media player according to one embodiment of the invention.

FIG. 8 is a screen shot depicting the point-of-purchase media player of FIG. 7 after the user has initiated playback of a preview of a video offered for sale through the point-of-purchase player, according to one embodiment of the invention.

FIG. 9 is a screen shot depicting the point-of-purchase media player of FIG. 7 with a payment screen that is displayed when the user makes a selection to purchase a video, according to one embodiment of the invention.

FIG. 10 is screen shot depicting the point-of-purchase media player of FIG. 7 with a payment confirmation screen that is displayed after the user completes the payment process initiated in FIG. 9, according to one embodiment of the invention.

FIG. 11 is a screen shot depicting the point-of-purchase media player of FIG. 7 after completion of the purchase, with the full purchased video available for viewing.

FIG. 12 is a screen shot depicting a portion of an online retailer web site that makes the video available for viewing after the video has been purchased.

FIG. 13 is a screen shot depicting a portion of the online retailer web site after a purchased video has been selected for viewing.

FIG. 14 is a screen shot depicting an e-mail that may be sent to the user to provide automatically generated login credentials according to one embodiment of the invention.

FIG. 15 is a screen shot depicting a login screen for an online retailer web site according to one embodiment of the invention.

FIG. 16 is a screen shot depicting a point-of-purchase media player embedded in a third-party web site according to another embodiment of the invention.

FIG. 17 is a screen shot depicting the point-of-purchase media player of FIG. 16 after a full video has been purchased, according to one embodiment of the invention.

FIG. 18 is a screen shot depicting a point-of-purchase media player according to another embodiment of the invention.

FIG. 19 is a screen shot depicting the point-of-purchase media player of FIG. 18 after the user has made a selection to enter a coupon, according to one embodiment of the invention.

### DETAILED DESCRIPTION OF THE EMBODIMENTS

For illustrative purposes, the systems and methods described and depicted herein may refer to systems and methods for purchasing goods and/or services online. In some embodiments, online purchasing of digital media, such as streaming digital video, may be provided. A point-of-purchase media player may be embedded in a third-party web site, and may be used to view and purchase a video without requiring the user to navigate away from the third-party web site.

### System Architecture

According to various embodiments, the present invention can be implemented on any electronic device equipped to receive, store, and present information. Such an electronic device may be, for example, a desktop computer, laptop computer, smartphone, tablet computer, or the like.

Although the invention is described herein in connection with an implementation in a computer, one skilled in the art will recognize that the techniques of the present invention can be implemented in other contexts, and indeed in any suitable device capable of receiving and/or processing user input. Accordingly, the following description is intended to illustrate various embodiments of the invention by way of example, rather than to limit the scope of the claimed invention.

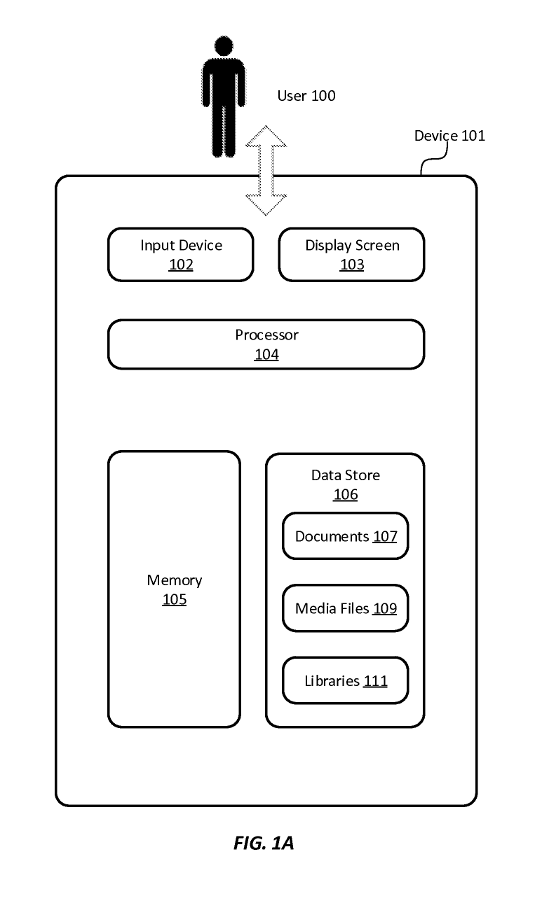

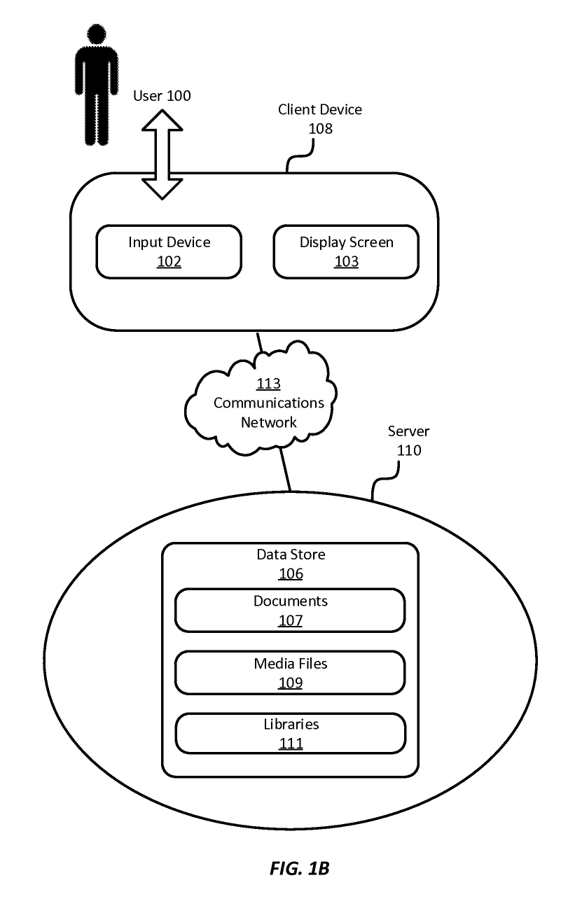

Referring now to FIG. 1A, there is shown a block diagram depicting a hardware architecture for practicing the present invention, according to one embodiment. Such an architecture can be used, for example, for implementing the techniques of the present invention in a computer or other device 101. Device 101 may be any electronic device equipped to receive, store, and/or present information, and to receive user input in connect with such information.

In at least one embodiment, device 101 has a number of hardware components well known to those skilled in the art. Input device 102 can be any element that receives input from user 100, including, for example, a keyboard, mouse, stylus, touch-sensitive screen (touchscreen), touchpad, trackball, accelerometer, five-way switch, microphone, or the like. Input can be provided via any suitable mode, including for example, one or more of: pointing, tapping, typing, dragging, and/or speech.

Data store 106 can be any magnetic, optical, or electronic storage device for data in digital form; examples include flash memory, magnetic hard drive, CD-ROM, DVD-ROM, or the like. In at least one embodiment, data store 106 stores information which may include documents 107, media files 109, and/or libraries 111 that can be utilized and/or displayed according to the techniques of the present invention, as described below. In another embodiment, documents 107, media files 109, and/or libraries 111 can be stored elsewhere, and retrieved by device 101 when needed for presentation to user 100. The libraries 111 may contain data that is not a document or a media file.

Media files 109 may include any of a wide variety of media types, including, for example, audio media, visual media, text files, transcripts, photos and other images, and/or audiovisual media. Visual and audiovisual media may include video and/or static images. The media files 109 may include any of a wide variety of compressed and uncompressed media file types known in the art. Media files 109 may also be encrypted and/or locked with digital rights management (DRM) or other known technologies, or may be unencrypted and/or unlocked. Media files 109 may optionally be designed for streaming over the Internet, and may thus have compression and/or encoding formats that are selected for secure on-line delivery. Additionally or alternatively, the media files 109 may be configured to be downloaded to and/or stored for a length of time determined by the user 100 on a computing device controlled by the user 100.

Display screen 103 can be any element that graphically displays documents 107, media files 109, libraries 111, and/or other output to the user 100. The display screen 103 may be configured to display web content such as web sites, streaming media, and the like for the user 100. In at least one embodiment where only some of the desired output is presented at a time, a dynamic control, such as a scrolling mechanism, may be available via input device 102 to change which information is currently displayed, and/or to alter the manner in which the information is displayed on the display screen 103. The information displayed on display screen 103 may include data in text and/or graphical form.

Processor 104 can be a conventional microprocessor for performing operations on data under the direction of software, according to well-known techniques. Memory 105 can be random-access memory, having a structure and architecture as are known in the art, for use by processor 104 in the course of running software.

Data store 106 can be local or remote with respect to the other components of device 101. In at least one embodiment, device 101 is configured to retrieve data from a remote data storage device when needed. Such communication between device 101 and other components can take place wirelessly, by Ethernet connection, via a computing network such as the Internet, or by any other appropriate means. This communication with other electronic devices is provided as an example and is not necessary to practice the invention.

In at least one embodiment, data store 106 is detachable in the form of a CD-ROM, DVD, flash drive, USB hard drive, or the like. Documents 107, media files 109, and/or libraries 111 can be entered from a source outside of device 101 into a data store 106 that is detachable, and later displayed after the data store 106 is connected to device 101. In another embodiment, data store 106 is fixed within device 101.

Referring now to FIG. 1B, there is shown a block diagram depicting a hardware architecture for practicing the present invention in a client/server environment, according to one embodiment of the present invention. Such an implementation may use a “black box” approach, whereby data storage and processing are done completely independently from user input/output. An example of such a client/server environment is a web-based implementation, wherein client device 108 runs a browser that provides a user interface for interacting with web pages and/or other web-based resources from server 110. Documents 107, data, and/or libraries 111 can be presented as part of such web pages and/or other web-based resources, using known protocols and languages such as Hypertext Markup Language (HTML), Java, JavaScript, and the like.

Client device 108 can be any electronic device incorporating the input device 102 and/or display screen 103, such as a desktop computer, laptop computer, personal digital assistant (PDA), cellular telephone, smartphone, music player, handheld computer, tablet computer, kiosk, game system, or the like. Any suitable type of communications network 113, such as the Internet, can be used as the mechanism for transmitting data between client device 108 and server 110, according to any suitable protocols and techniques. In addition to the Internet, other examples include cellular telephone networks, EDGE, 3G, 4G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, client device 108 transmits requests for data via communications network 113, and receives responses from server 110 containing the requested data.

In this implementation, server 110 is responsible for data storage and processing, and incorporates data store 106 for storing documents 107, media files 109, and/or libraries 111. Server 110 may include additional components as needed for retrieving documents 107, media files 109, and/or libraries 111 from data store 106 in response to requests from client device 108.

In at least one embodiment, documents 107, media files 109, and/or libraries 111 are organized into one or more well-ordered data sets, with one or more data entries in each set. Data store 106, however, can have any suitable structure. Accordingly, the particular organization of documents 107, media files 109, and/or libraries 111 within data store 106 need not resemble the form in which documents 107, media files 109, and/or libraries 111 are displayed or played to user 100 or used by the client device 108. In at least one embodiment, an identifying label is also stored along with each data entry, to be displayed along with each data entry.

In at least one embodiment, documents 107, media files 109, and/or libraries 111 are organized in a file system within data store 106. Appropriate indexing can be provided to associate particular documents with particular quantitative data elements, reports, other documents, and/or the like. Documents 107, media files 109, and/or libraries 111 may include any of a wide variety of data structures known in the database arts.

Documents 107, media files 109, and/or libraries 111 can be retrieved from client-based or server-based data store 106, and/or from any other source. In at least one embodiment, input device 102 is configured to receive user selections from the user 100 for documents 107, media files 109, and/or libraries 111 to be displayed on the display screen 103 or otherwise used by the user 100. User 100 may provide such selections via the hardware and software components described above according to means that are well known to those skilled in the art.

Display screen 103 can be any element that graphically displays documents 107, media files 109, libraries 111, and/or other output to the user 100. The display screen 103 may be configured to display web content such as web sites, streaming media, and the like for the user 100. In at least one embodiment where only some of the desired output is presented at a time, a dynamic control, such as a scrolling mechanism, may be available via input device 102 to change which information is currently displayed, and/or to alter the manner in which the information is displayed on the display screen 103. The information displayed on display screen 103 may include data in text and/or graphical form.

In one embodiment, the system can be implemented as software written in any suitable computer programming language, whether in a standalone or client/server architecture. Alternatively, it may be implemented and/or embedded in hardware.

### Conceptual Architecture

In at least one embodiment, the system of the present invention facilitates online purchasing of products or services via a third party web site independent of the online retailer that sells the products or services. Payment processing functionality may be provided independently of any need for the user to navigate to the online retailer's web site. Thus, the purchase may be completed without the need to navigate away from the third-party web site. If the purchased item consists of digital media, the user may play the digital media via the third-party web site or via the online retailer's web site. In at least one embodiment, the system of the present invention automatically creates an account for the user; the account may then be used to enable playback of purchased digital content on other devices.

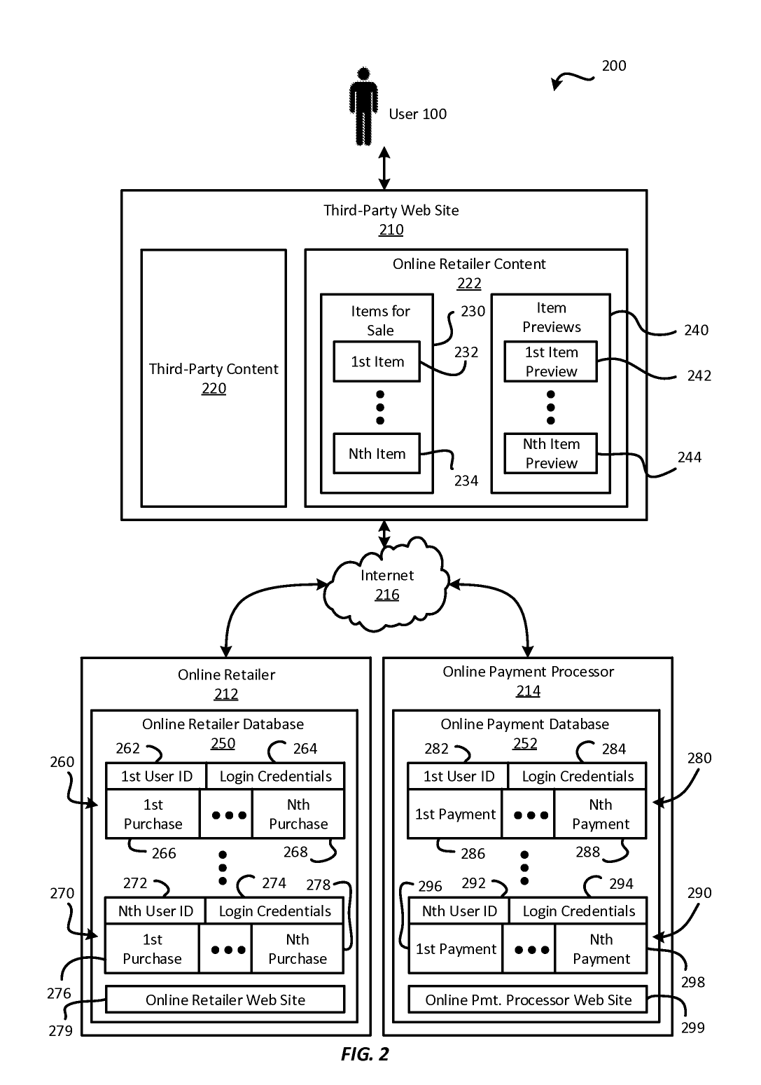

FIG. 2 is a block diagram depicting a system 200 for initiating purchasing through a third-party web site. As shown, the system 200 may include a third-party web site 210, an online retailer 212, and an online payment processor 214, which may communicate with each other over the Internet 216.

The online retailer 212 may be any entity that sells products or services via the Internet 216. The online retailer 212 may sell any type of service or product; in one embodiment, the online retailer 212 may sell access to streaming digital media (also referred to as digital content) such as digital videos, music, speech, pictures, and the like. The following disclosure will focus on the example of digital video sales; however, those of skill in the art will recognize that the principles and teachings of the present invention could be readily applied to any type of digital media, and indeed, to any tangible or intangible product or service.

The online payment processor 214 may be any entity that conducts payment transactions over the Internet 216. The online payment processor 214 may receive and process payments via credit cards, debit cards, bank withdrawals, online retailer credit accounts, credit accounts managed by the online payment processor 214, or any other known payment mechanism. One example of a payment processor is PayPal. If desired, the online payment processor 214 may use a streamlined portal such as PayPal's Express Checkout for Digital Goods system rather than a full web site to conduct payment transactions.

The third-party web site 210 may be a web site that is not affiliated with the online retailer 212 or the online payment processor 214. For example, the party web site 210 may be a site that hosts content of interest to the user 100. The third-party web site 210 may display advertisements and/or links to other groups such as the online retailer 212. The advertisements and/or links may be free, paid, exchanged, or otherwise agreed upon between the third party who hosts the third-party web site 210 and the online retailer 212.

The third-party web site 210, the online retailer 212, and the online payment processor 214 may each be implemented with one or more servers, web sites, and/or other software and hardware architecture known in the art for communications over the Internet. The online retailer 212 and the online payment processor 214 may each have a web site, application, or other user-oriented portal; however, with the aid of the present invention, the online retailer 212 and/or the online payment processor 214 need not be designed for direct communication with the user 100.

Rather, if desired, the user 100 may make purchases without navigating to or otherwise communicating directly with the online retailer 212 and/or the online payment processor 214. If desired, the identity of the online retailer 212 and/or the online payment processor 214 may not be known to the user 100 so that the user 100 is only aware of dealing with the third-party web site 210. In the alternative, the online retailer 212 and the online payment processor 214 may each have online portals and/or user accounts available to the user 100. Thus, payments and/or purchases made by the user 100 may be stored and compiled and made accessible to the user 100 via web sites, applications, or other communications media hosted by the online retailer 212 and/or the online payment processor 214.

As shown in FIG. 2, the third-party web site 210 may include third-party content 220 and online retailer content 222. The third-party content 220 may be any type of content the third party wishes to display to the user 100, including but not limited to text, multimedia, interactive applications such as script-based applications like JavaScript, and the like. The third-party content 220 may be designed to simply convey information to the user 100, sell products to the user 100, provide entertainment, or any other function.

The online retailer content 222 may be embedded in the third-party web site 210. Thus, at least a portion of the online retailer content 222 may be displayed on the display screen 103 alongside at least a portion of the third-party content 220. The embedding may be carried out such that the user 100 can view the online retailer content 222 without hiding, minimizing, or navigating away from the third-party content 220. In the context of enabling purchasing of digital media, the online retailer content 222 may include a video player capable of playing one or more digital videos available for purchase and/or one or more previews of one or more digital videos available for purchase.

In one embodiment, the third-party web site 210 may be coded with HTML, and the online retailer content 222 may be embedded in the party web site 210 as an iFrame contained within the HTML code of the third-party web site 210. The iFrame may be capable of determining the video technology that is most appropriate based on the browser used by the user 100, the manner in which the party web site 210 is coded, the speed of the connection of the user 100 to the party web site 210, and/or a variety of other factors. According to some embodiments, such an iFrame may default to video playback via Adobe Flash unless the required version of Adobe Flash is not installed. In such an event, the iFrame may provide playback via HTML5, using the browser's native HTML5 controls and/or behavior, or via any other mechanism for displaying video content.

As further shown in FIG. 2, the online retailer content 222 may present, to the user 100, one or more items for sale 230 and/or one or more item previews 240. The items for sale 230 may include a first item 232 and, optionally, one or more additional items up to an nth item 234. Similarly, the item previews 240 may include a first item preview 242 and, optionally, one or more additional items up to an nth item 244. Each of the item previews 240 may optionally be connected (for example, visually) to one of the items for sale 230 so that the user 100 can browse the items for sale 230 and, if desired, view one of the item previews 240 for each of the items for sale 230.

In the context of enabling the purchase of digital video, the items for sale 230 may be digital videos, which may, after purchase, be streamed to the user 100 over the Internet 216. The item previews 240 may be subsets of the digital videos that can be streamed to the user 100 for viewing prior to purchase. Each preview may be a subset (i.e., a clip) of the corresponding digital video that is for sale. Displaying the online retailer content 222 to the user 100 may entail displaying an embedded video player in a paused state to provide the item previews 240. The items for sale 230 may be indicated by text that accompanies the video player. In order to simultaneously present more than one of the item previews 240, the online retailer content 222 may include multiple embedded video players, or may include pictures or links that expand the online retailer content 222 on the display screen 103 and/or cause a popup window to appear on the display screen 103 with the corresponding preview.

The online retailer content 222 may additionally or alternatively display information not shown in FIG. 2. For example, the name of the online retailer, identification of other products or services for sale that are not available for purchase through the third-party web site 210, links to additional information about the items for sale 230, and/or a link to a web site operated by the online retailer 212 may optionally be provided as part of the online retailer content 222.

As mentioned previously, the online retailer 212 may also have a web site, or may simply communicate through the Internet 216 in a manner that is transparent to the user 100. The online retailer 212 may have an online retailer database 250 including, for example a first user record 260 and optionally, a one or more additional user records up to an nth user record 270.

The first user record 260 may have a first user ID 262, which may be a name, ID number, e-mail address, and/or other identifier for a first user (for example, the user 100). The first user ID 262 may optionally be unique so that the first user ID 262 can also serve as a unique identifier for the first user record 260. The first user record 260 may also have login credentials 264 that pertain to the user 100. The login credentials 264 may include a username, e-mail address, password, security question, answer to a security question, authentication image, and/or any other elements known in the art that can be used to verify the identity of the user 100.

The first user record 260 may be used to record purchases made by the user 100. Thus, the first user record 260 may contain a first purchase 266, and may optionally also contain one or more additional purchases up to an nth purchase 268. The first purchase 266 through the nth purchase 268 may contain data such as SKU numbers for goods or services purchased in each purchase by the user 100, the amount paid for each purchase, the date of the purchase, the physical or virtual location at which each good or service was purchased, warranty information, and/or any other information that may be helpful to the online retailer 212 and/or the user 100.

Each of the other user records of the online retailer database 250, up to the nth user record 270, may have elements that correspond to those described above for the first user record 260. Thus, the nth user record 270 may have an nth user ID 272, login credentials 274, a first purchase 276, and optionally, one or more additional purchases up to an nth purchase 278. The nth user ID 272, the login credentials 274, the first purchase 276, and the remaining purchases up to the nth purchase 278 may be different from their counterparts of the first user record 260 and may contain different data and/or records of different types or quantities. For example, the nth user may not have the same number of purchases as the user 100; thus, the nth user record 270 may contain a number of purchases different from that of the first user record 260.

Purchases made by the user 100 through the third-party web site 210 may be recorded in the online retailer database 250. Thus, even though a purchase may be transacted without direct communication between the user 100 and the online retailer 212, the online retailer 212 may have a record of the purchase. This may help the online retailer 212 to provide refunds or warranty service, suggest additional products, or provide other products or services useful to the user 100.

The online retailer 212 may optionally have an online retailer web site 279. The online retailer web site 279 may enable the user 100 to browse, preview, and/or purchase goods or services such as the items for sale 230 of the online retailer content 222. The online retailer web site 279 may optionally offer a greater selection of items for sale 230 and/or item previews 240 than is available in the online retailer content 222 on the third-party web site 210.

A user such as the user 100 may use his or her login credentials 264 to log in to his or her account, and may have access to some or all of the information in the first user record 260. Returning to the digital media example, the user 100 may also, once logged into the retailer web site, be able to play or replay digital media (in the case of web-hosted digital media such as streaming digital media), or download digital media (in the case of downloadable content) he or she has already purchased.

The online payment processor 214 may have some of the same features and components set forth in the description of the online retailer 212. However, in the online payment processor 214, such features and components may be geared toward tracking user payments. These payments may be for multiple online retailers.

More precisely, the online payment processor 214 may have an online payment database 252, which may include information regarding payments. For example, the online payment database may include a first user record 280 and optionally, a one or more additional user records up to an nth user record 290.

The first user record 280 may have a first user ID 282, which may be a name, ID number, e-mail address, and/or other identifier for a first user (for example, the user 100). The first user ID 282 may optionally be unique so that the first user ID 282 can also serve as a unique identifier for the first user record 280. The first user record 280 may also have login credentials 284 that pertain to the user 100. The login credentials 284 may include a username, e-mail address, password, security question, answer to a security question, authentication image, and/or any other elements known in the art that can be used to verify the identity of the user 100.

The first user record 280 may be used to record purchases made by the user 100. Thus, the first user record 280 may contain a first payment 286, and may optionally also contain one or more additional payments up to an nth payment 288. The first payment 286 through the nth payment 288 may contain data such as SKU numbers for goods or services purchased in each purchase by the user 100, the amount paid for each purchase, the date of the purchase, the physical or virtual location at which each good or service was purchased, the credit card, debit card, bank account, credit account, or other facility by which payment was made, the name of the retailer for which the payment was processed, and/or any other information that may be helpful to the online payment processor 214 and/or the user 100.

Each of the other user records of the online payment database 252, up to the nth user record 290, may have elements that correspond to those described above for the first user record 280. Thus, the nth user record 290 may have an nth user ID 292, login credentials 294, a first payment 296, and optionally, one or more additional payments up to an nth payment 298. The nth user ID 292, the login credentials 294, the first payment 296, and the remaining payments up to the nth payment 298 may be different from their counterparts of the first user record 280 and may contain different data and/or records of different types or quantities. For example, the nth user may not have the same number of payments as the user 100; thus, the nth user record 290 may contain a number of payments different from that of the first user record 280.

Payments made by the user 100 through the third-party web site 210 may be recorded in the online payment database 252. If desired, the online payment processor 214, like the online payment processor 214, may record information from transactions made through the third-party web site 210, with no direct interaction between the user 100 and the online payment processor 214. Alternatively, the online payment processor 214 may handle payments directly with the user 100. In either case, the online payment processor 214 may have a record of the payment. This may help the online payment processor 214 to provide payment information to the user 100, provide warranty or other support in dealing with the online retailer 212, or provide other useful products or services to the user 100.

The online payment processor 214 may optionally have an online payment processor web site 299. The online payment processor web site 299 may enable the user 100 to enter payment options, review prior payment transactions, access credit accounts, and the like. Thus, the user 100 may use his or her login credentials 284 to log in to his or her account, and may have access to some or all of the information in the first user record 280.

In alternative embodiments, payment processing functionality may be integrated into the third-party web site 210 and/or the online retailer 212. Such integration may make the involvement of the online payment processor 214 unnecessary. Rather, once the user 100 selects one or more item(s) for purchase, the online payment transaction may be performed directly by the third-party web site 210 or by the online retailer 212.

### Purchasing Method

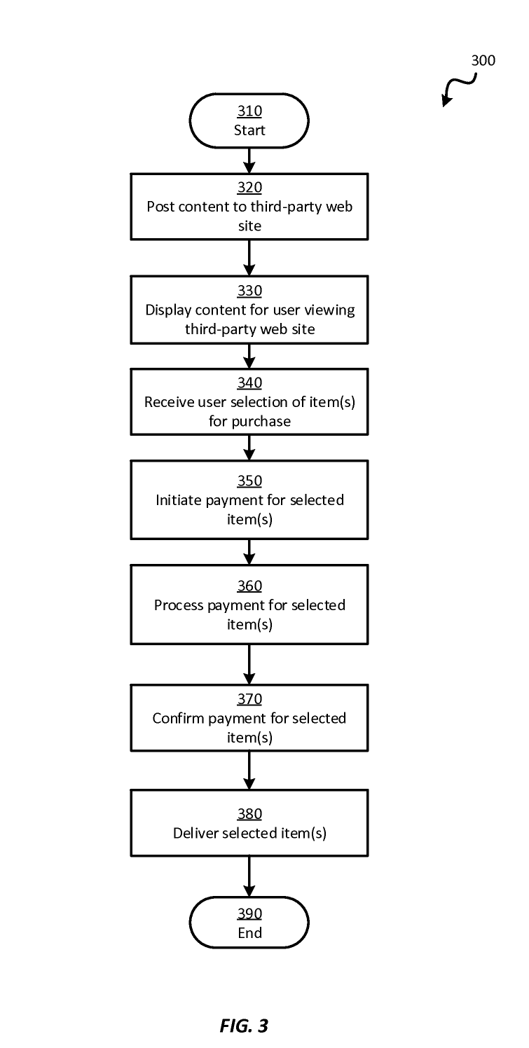

Referring to FIG. 3, a flowchart depicts a method 300 of carrying out online purchasing according to one embodiment of the present invention. As shown, the method 300 may start 310 with a step 320 in which the online retailer content 222 is posted to the third-party web site 210, as in the configuration of FIG. 2. The online retailer content 222 may take the form of an advertisement, link, or other portion of a web page. The online retailer content 222 may be embedded in the party web site 210, i.e., displayed within the same browser window, frame, or other user interface element as the third-party content 220 so as to be viewable on the display screen 103 simultaneously with the third-party content 220.

In alternative embodiments, the online retailer content 222 may be in a separate window from the third-party content 220, or may be otherwise associated with the third-party content 220 without being embedded in the party web site 210. The present invention may also be used in connection with such embodiments, so that the user need not navigate away from the third-party web site 210 in order to make a purchase from the online retailer 212. However, the following description focuses on embodiments in which the online retailer content 222 is embedded in the third-party web site 210.

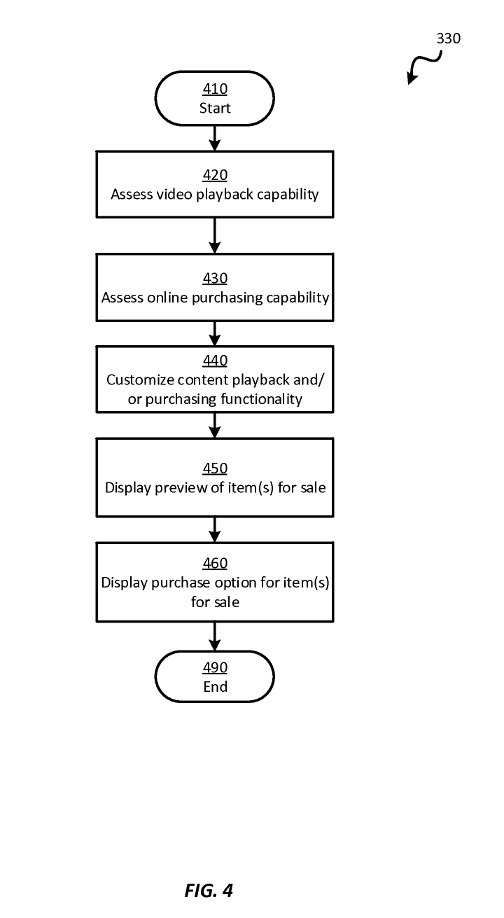

Once the online retailer content 222 has been posted to the third-party web site 210, the method may proceed to a step 330 in which the online retailer content 222 is displayed for a user (i.e., the user 100) viewing the third-party web site 210. As mentioned previously, the online retailer content 222 may be displayed above, below, alongside, in the midst of, or otherwise proximate the third-party content 220. Thus, the user 100 may navigate to the third-party web site 210 for the purpose of viewing the third-party content 220, and may additionally be presented with the online retailer content 222. The online retailer content 222 may present one or more items for sale. Each “item” may be a good or service, or a bundle of goods and/or services. Possible component steps for the step 330 will be shown and described subsequently in connection with FIG. 4.

Once the online retailer content 222 has been displayed for the user 100, the method 300 may proceed to a step 340 in which a selection is received from the user 100 designating one or more of the items presented by the online retailer content 222 that are to be purchased. This may be done, for example, by receiving user input clicking on one or more menu selections of the online retailer content 222 for the item(s) to be purchased. The item(s) may be purchased in a multi-step process, such as a process in which the item(s) are first placed in a shopping cart or similar virtual receptacle, and then purchased in a check-out or other transaction finalizing step. In the alternative, the item(s) may be purchased in a single step as in one-click purchasing.

Once the selection of item(s) to be purchased has been received, the method 300 may proceed to a step 350 in which payment for the selected item(s) is initiated. This may be done in any of a wide variety of ways. If the third-party web site 210 has the capability to process payments, the online retailer content 222 may utilize the payment processing capability of the third-party web site 210. If the third-party web site 210 cannot process payments, the step 350 may involve referencing a different payment processor such as the online payment processor 214. As mentioned previously, in some embodiments, payment processing may be initiated through the online retailer 212.

The step 350 may beneficially be carried out in a way that does not require navigation away from the third-party web site 210. Thus, the third-party web site 210 may continue to benefit from the traffic provided by the user 100, and the user 100 may continue his or her experience on the third-party web site 210. This may effectively lower the purchasing barrier for the user 100, thereby making it faster and easier to make a purchase. This may, in turn, increase the success rate of the online retailer content 222, by comparison with advertisements and other links that require navigation to a separate web site to complete a purchase.

If desired, payment processing functionality may be integrated into a point-of-purchase media player so that the payment can be processed without the need to open a separate window. In one alternative, payment processing may occur with a popup browser window or the like. In another alternative, the step 350 may involve the use of a separate application, such as a computer program or smartphone app, that is designed to process payments.

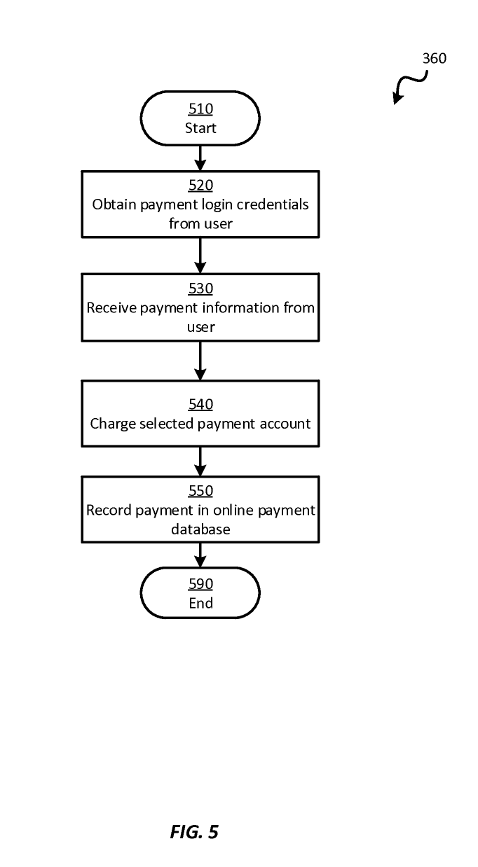

Once the payment has been initiated, the method 300 may proceed to a step 360 in which payment is processed for the selected item(s). Processing payment may be done in a wide variety of ways, and may involve receipt of payment information for a payment method selected by the user. Exemplary component steps for the step 360 will be shown and described in connection with FIG. 5.

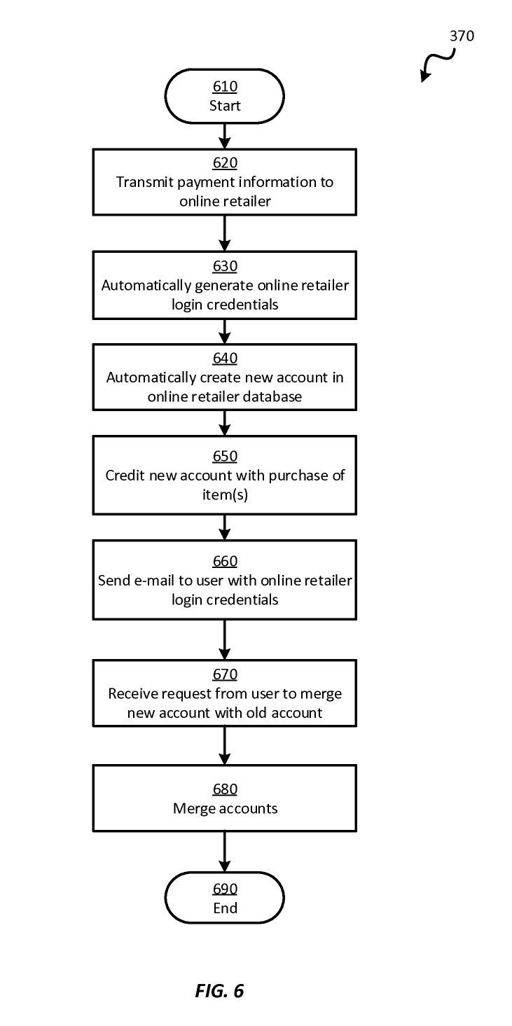

Once the payment has been processed, the method 300 may proceed to a step 370 in which the payment for the selected item(s) is confirmed, for example, by the online retailer 212. Confirmation may include communication between the online retailer 212 and the online payment processor 214, as will be set forth in greater detail subsequently. Exemplary component steps for the step 370 will be shown and described in connection with FIG. 6.

In addition to or in the alternative to the foregoing, where the item(s) being purchased include one or more digital media files, the step 370 may involve authorizing a computing device used by the user 100 to receive and/or play the digital media files. Authorizing the computing device may be done in one of several ways.

According to some embodiments, authorization may be carried out by storing information in the online retailer database 250. For example, an identifier for the computing device, such as an IP address or MAC address, may be recorded in the online retailer database 250 and associated with one or more item(s) that are authorized to be received and/or played on the computing device.

In alternative embodiments, authorization may be carried out by storing information on the computing device. For example, a cookie or token may be copied to the computing device as part of the authorization process. Various codes and/or encryptions may be used to make it more difficult to falsify such a token or cookie. In at least one embodiment, video security may be handled by utilizing token-based authentication such as that provided by EdgeCast Networks Inc. This may prevent users from accessing the content directly by sharing a URL.

Once confirmation of the payment has been received, the method 300 may proceed to a step 380 in which the selected item(s) are delivered to the user 100. Where the selected item(s) are tangible, they may be shipped or otherwise made available for receipt by the user 100 in a variety of known methods. Where the item(s) include one or more digital media files, such item(s) may be copied, streamed, or otherwise made available to the user 100 via the Internet 216.

If desired, the selected item(s) may be delivered according to preferences or other settings established in a user account maintained by the online retailer 212 for the user 100. Returning to the example of streaming digital video, the user 100 may be credited by the online retailer 212 with the purchase of a video. The video may then be played on any device operated by the user 100. One way to enable this functionality is to have the user 100 log into the online retailer web site 279 or to an application running on the device the user 100 wishes to use to view the video. Presenting the proper login credentials may establish, for the online retailer 212, that the device is being operated by the user 100.

Advantageously, the account for the user 100 may be created automatically in the course of making a purchase. For example, login credentials 264 may automatically be created for the user 100 by the online retailer 212, and may be sent to the user 100 via e-mail or the like. The user 100 may then have the option to keep the login credentials 264 that were automatically generated, or to replace them with his or her own login credentials.

A logged-in user may be presented with the option to view any videos that he or she has already purchased at no additional cost. This may be done, for example, on the online retailer web site 279 or on an application operated by the online retailer 212. Additionally or alternatively, repeated viewing may be offered over the third-party web site 210. Thus, the user 100 may have the option to navigate back to where he or she originally purchased and/or viewed the video in order to view it again without purchasing it a second time.

According to some embodiments, delivery of digital media files may be carried out only after authentication of the user's computing device has been verified. The manner in which this is done may depend on the manner in which authentication was carried out.

For example, if authentication was done with information stored in the online retailer database 250, the online retailer 212 may compare the IP address, MAC address, or other identifier from the online retailer database 250 with that of the user 100 attempting to play or download the digital media file(s). If the identifier of the computing device matches that listed in the online retailer database 250, the requested digital media file(s) may be played for the user.

If the authentication was done with information stored on the computing device, verification may be done by checking the token, cookie, or other item stored on the computing device of the user 100 to ensure that it is valid. This may involve the performance of mathematical operations on the data of the token, cookie, or other item and/or comparison of the token, cookie, or other item with a reference copy stored in the online retailer database 250. If the token, cookie, or other item satisfies mathematical and/or comparison-based criteria, the requested digital media file(s) may be played for the user 100.

Once the purchased item(s) have been delivered to the user 100, the method 300 may be complete and may end 390. The method 300 may be carried out again to enable the purchase of additional items. Such additional items may be purchased, credited to a user account on the online retailer database 250 for the user 100, and delivered to the user 100 in accordance with the steps set forth above.

Referring to FIG. 4, a flowchart depicts the step 330 of the method 300 of FIG. 3 in greater detail, according to one embodiment of the invention. As set forth previously, in the step 330, the online retailer content 222 may be displayed for a user viewing the third-party web site 210. The step 330 may have several component steps as set forth below.

The step 330 may start 410 with a step 420 in which the video playback capability through the party web site 210 is assessed. This may include an assessment of the technology for delivering, transmitting, and/or playing video on the third-party web site 210, a server hosing the third-party web site 210, a browser used by the user 100, and/or the computing device used by the user 100. Hardware, software, upload speed, and/or download speed issues may be taken into account as the assessment is performed.

The assessment may be used to determine whether certain software is present. For example, in the step 420, the online retailer content 222 may determine whether Adobe Flash is present on the computing device used by the user 100. The step 420 may be uniquely necessary for digital media and may be omitted for purchases of other goods or services.

The step 330 may then proceed to a step 430 in which the online purchasing capability available for the online retailer content 222 is assessed. As in the step 420, the step 430 may include a variety of hardware, software, and/or Internet connectivity tests. In some embodiments, the step 430 may include a determination of whether the third-party web site 210 and/or the online retailer 212 supports online payment processing. The step 430 may include a determination of whether the necessary protocols, such as Secure Socket Layer (SSL), are in place on the third-party web site 210 and/or the online retailer 212.

Once the assessments of the step 420 and the step 430 have been performed, the step 330 may proceed to a step 440 in which the playback capability and/or online purchasing functionality provided by the online retailer content 222 are customized. Customization of the online retailer content 222 may provide the best possible experience for the user 100 while taking into account the hardware, software, and/or Internet connectivity limitations discovered in the step 420 and/or the step 430.

The online retailer content 222 may utilize a lowest common denominator approach. Thus, for example, the online retailer content 222 may use Adobe Flash if it is installed on the browser used by the user 100. If Adobe Flash has not been installed, the online retailer content 222 may instead use HTML5 or another video playback technology. As another example, if the third-party web site 210 supports online purchasing, the online retailer content 222 may carry out online purchasing through the third-party web site 210. If not, online purchasing may be carried out through the online retailer 212. If the online retailer 212 also does not support online purchasing, the online retailer content 222 may be customized to use the online payment processor 214.

In a step 450, one or more previews are displayed for the item(s) for sale. Each preview may include text, one or more images, one or more audio clips, one or more video clips, or any combination of the foregoing. Each item for sale may have its own preview, or there may be a single preview for multiple items or multiple previews for a single item.

In the case of digital video, each preview may be a subset, i.e., a “clip,” of the full digital video that is available for purchase. The step 450 may include displaying an image from the clip, such as a frame from the clip in a paused state. The step 450 may further include playing the clip when the user clicks on the image, on an associated “play” button, or the like.

The step 330 may also include a step 460 in which a purchase option is displayed for the item(s) for sale. This may be done before, after, or while the preview is being displayed. Returning to the example of digital video sales, a purchase option (for example, a button indicating “Buy Now” and/or a price for the full video) may be displayed alongside the preview as it plays so that the user 100 need not stop the preview or wait for the end of the preview to initiate a purchase. After the preview and the purchase option have been displayed, the step 460 may end 490.

In the event that the user 100 has already purchased the item, the step 460 may be replaced with a step in which the option is displayed for the user 100 to view the status of delivery of the purchased item(s) and/or, if applicable, receive the purchased item(s) again. For example, returning to the example of digital video, in place of a “Buy Now” button, a “Watch Now” button may be displayed for any video that has already been purchased by the user 100. The existence of a prior purchase may be confirmed by validating authorization of a computing device used by the user 100 and/or allowing the user 100 to log into his or her account, as set forth previously.

Referring to FIG. 5, a flowchart depicts the step 360 of the method 300 of FIG. 3 in greater detail, according to one embodiment of the invention. As mentioned previously, in the step 360, payment for the selected item(s) may be processed. The manner in which this is carried out may depend on whether online payment can be accepted through the third-party web site 210 or the online retailer 212. The following method assumes that the involvement of the online payment processor 214 is needed. Thus, some or all of the component steps of the step 360 may be carried out by the online payment processor 214.

The step 360 may start 510 with a step 520 in which the proper login credentials for the user 100 are received. These may be login credentials that were previously established by the user 100 from previous interactions with the online payment processor 214. Alternatively, they may be new login credentials representing the creation of a new account for the user 100 with the online payment processor 214. A wide variety of login and/or account creation screens and menus may be used to accomplish this, as known in the art.

Once the user 100 has established his or her credentials with the online payment processor 214, the step 360 may proceed to a step 530 in which payment information is received from the user 100. The payment information may indicate the manner in which payment will be provided. Thus, the step 530 may include provision by the user 100 of credit card information, debit card information, bank account information, credit account information, or the like. In the event that such information has already been provided to the online payment processor 214, the step 530 may simply entail selection of the payment method the user 100 wishes to use from a menu or list of payment methods for which the user 100 has already provided details.

Once the payment information has been received, the step 360 may proceed to a step 540 in which the selected payment account is charged. This may entail creating a debit entry for a bank account, credit account, credit card, debit card, or the like. The funds may be transferred by the online payment processor 214 to the online retailer 212 by any of a variety of methods. When the selected payment account has been charged, the step 360 may proceed to a step 550 in which the payment is recorded in the online payment database 252. The step 360 may then end 590.

Referring to FIG. 6, a flowchart depicts the step 370 of the method 300 of FIG. 3 in greater detail, according to one embodiment of the invention. As indicated previously, in the step 370, payment may be confirmed to the online retailer 212. The following method steps assume that the online payment processor 214 is the entity that collected the payment and is providing the corresponding information to the online retailer 212.

The step 370 may start 610 with a step 620 in which information related to the payment is transmitted to the online retailer 212 by the online payment processor 214. The payment information transmitted may include all or part of the first user ID 282, such as the user's name, address, phone number, unique identifier, or the like. The step 620 may also include transmission of part or all of the login credentials 284 of the user 100 to the online retailer 212. The login credentials 284 may help the online retailer 212 to properly identify the user 100. In the alternative, the login credentials 284 may be kept confidential by the online payment processor 214 and not shared with the online retailer 212.

The step 620 may also include transmission of the payment information (for example, the nth payment 288 shown in FIG. 2) to the online retailer 212. This may indicate to the online retailer 212 what item was purchased. If desired, the nth payment 288 may include a SKU or other code easily recognized by the online retailer 212 to properly identify the item(s) purchased by the user 100.

The information received by the online retailer 212 from the online payment processor 214 may be recorded in the online retailer database 250. Thus, the online retailer 212 may have a record of what the user 100 purchased, even if it was not the entity that processed the payment.

If desired, in a step 630, the online retailer 212 may automatically generate login credentials (for example, the login credentials 264) for the user 100. The step 370 may also include a step 640 in which the online retailer 212 automatically creates a new account for the user 100 in the online retailer database 250. The login credentials 264 may provide access to the new account (for example, via the online retailer web site 279) and may, for example, provide access to the information in the first user record 260 and/or associated items purchased by the user 100.

The online retailer 212 may, in a step 650, credit the new account with purchase of the item(s). This may entail creating one or more new entries in the first user record 260 for each item purchased. For example, the first purchase 266 through the nth purchase 268 may be created in the first user record 260.

In a step 660, the online retailer 212 may send an e-mail to the user 100 with the login credentials 264 which were automatically generated in the step 630. As mentioned previously, the login credentials 264 may be used to access the new account. The user 100 may already have a previously-created account with the online retailer 212. The previously-created account may have information related to previous purchases made by the user 100.

Rather than maintaining two separate accounts with the online retailer 212, the user 100 may desire to consolidate the accounts by shifting his or her purchase information from the new account to the previously-created account. This shift may be initiated in a step 670, in which the online retailer 212 receives a request from the user 100 to merge the new account with the previously-created one. The online retailer 212 may provide a web page or other online facility that facilitates the actions needed to make such a request.

If desired, the online retailer 212 may automatically detect the presence of user accounts that likely belong to the same user. A variety of known deduplication techniques may be used to facilitate this process. Such techniques may include, for example, searching for duplicate e-mail addresses, IP addresses, MAC addresses, or the like among the user record 260 through the user record 270. According to some examples, when two potentially duplicative accounts are found, the online retailer 212 may prompt the user 100 to merge them. Alternatively, the online retailer 212 may automatically merge the duplicative accounts, with or without notice to the user 100.

In a step 680, the two accounts may be merged. This may, for example, by copying the payment information from the new account into the old one. This may be desirable because the user 100 is likely more familiar with the previously-created account and the associated login credentials, which may have been created by the user 100 rather than automatically generated. Thus, the purchases of the first user record 260 (for example, the first purchase 266 through the nth purchase 268) may be copied into the user record for the previously-created account (for example, the nth user record 270) by appending them to the first purchase 276 through the nth purchase 278 that were already present in the nth user record 270. Then, the first user ID 262 and/or the login credentials 264 for the first user record 260 may be deleted.

In at least one embodiment, consolidation of the accounts belonging to the user 100 is optional. If desired, the user 100 may elect to keep both accounts and maintain them separately. The step 370 may then end 690.

### EXAMPLES

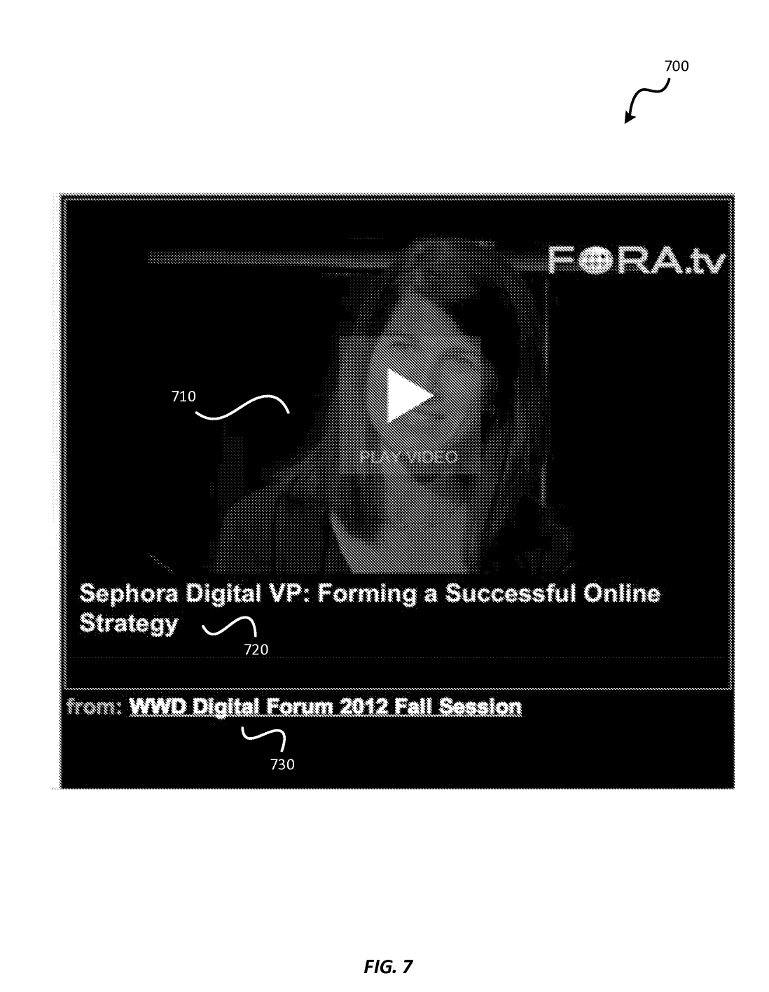

The present invention may be implemented in a wide variety of ways. FIGS. 7-19 present screen shots of various embodiments that relate to use of the present invention for online purchase of digital video. These screen shots are merely exemplary; those of skill in the art will recognize that a wide variety of different formats, menu structures, navigational pathways, and the like may be used to implement the present invention.

Referring to FIG. 7, a screen shot depicts an initial view of a point-of-purchase media player 700 according to one embodiment of the invention. The point-of-purchase media player 700 may be embedded in a web site such as the third-party web site 210, and may thus be proximate the party content 220, which is not shown in FIG. 7 for clarity.

As shown, the point-of-purchase media player 700 may have a video pane 710, which may display a preview of a video offered for sale through the point-of-purchase media player 700. The point-of-purchase media player 700 may also display a title 720 of the video previewed in the video pane 710, and a compilation 730 of which the video previewed in the video pane 710 is a part. When the point-of-purchase media player 700 is first displayed, the preview may be in a paused state until the user takes action (such as clicking on the video pane 710).

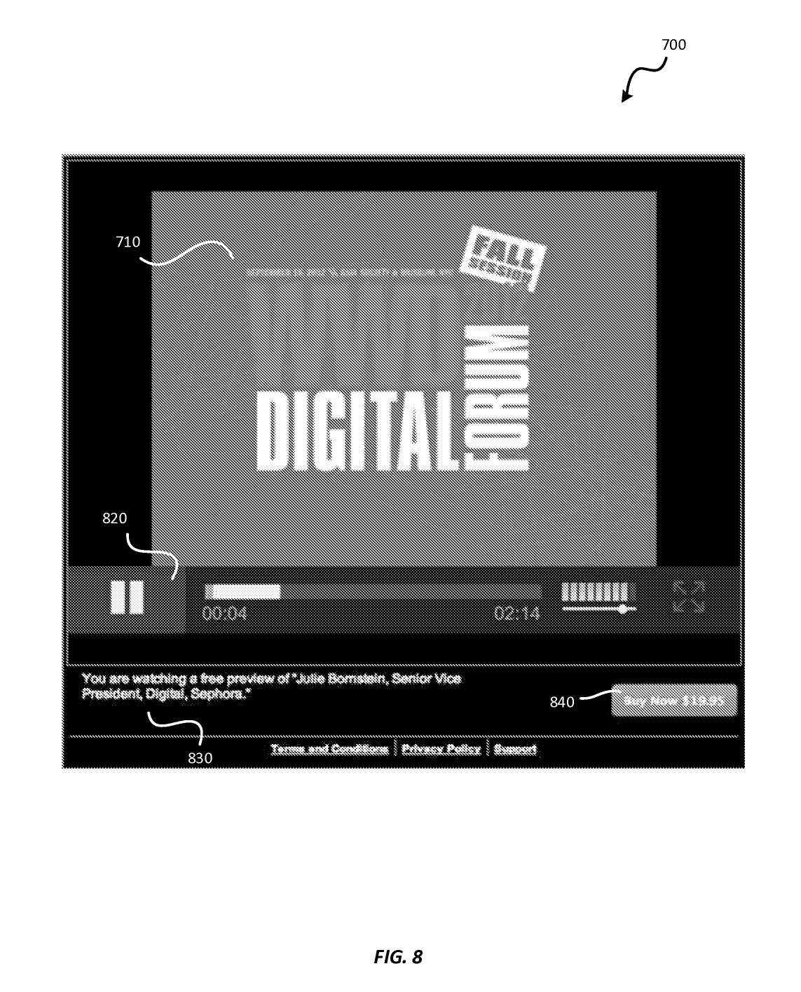

Referring to FIG. 8, a screen shot depicts the point-of-purchase media player 700 of FIG. 7 after the user has initiated playback of the preview, according to one embodiment of the invention. As shown, the video pane 710 may play the preview for the user 100. A control bar 820 may also be provided to allow the user 100 to control playback of the preview with controls such as play, pause, and a time slider that permits the user to skip to a desired portion of the preview. A status indicator 830 may indicate to the user what preview is being shown, and a purchase option 840 that can be selected (for example, by clicking on it) to allow the user to purchase the full video corresponding to the preview being shown.

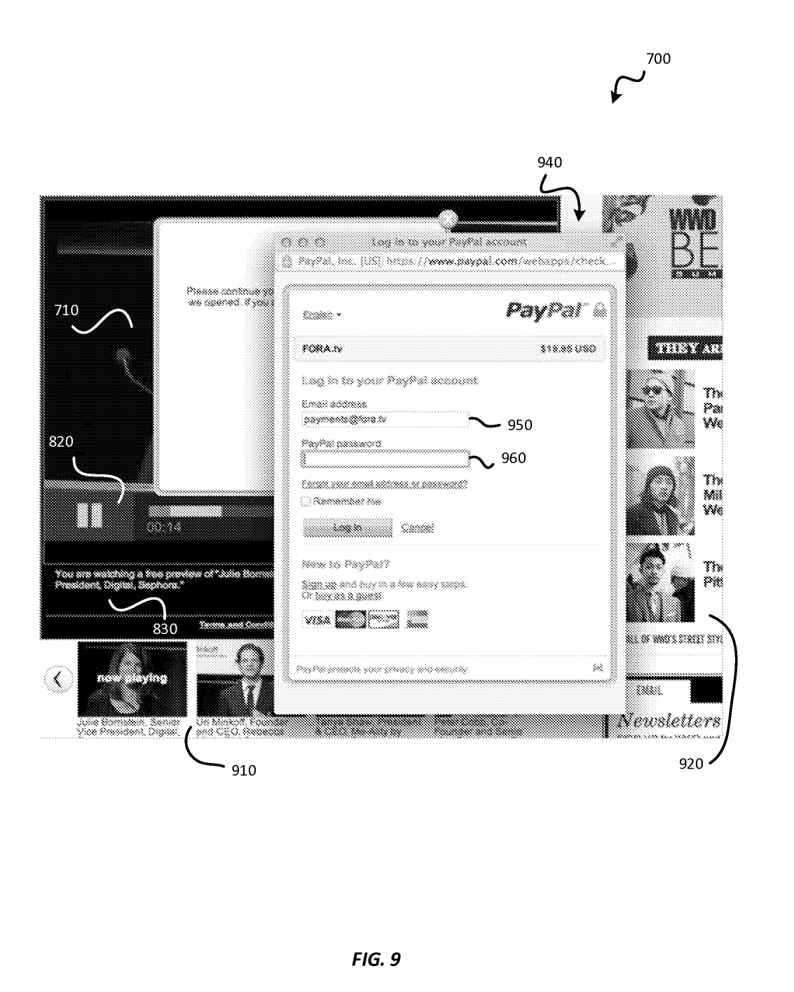

Referring to FIG. 9, a screen shot depicts the point-of-purchase media player 700 of FIG. 7 with a payment screen 940 that is displayed when the user 100 makes a selection to purchase a video, according to one embodiment of the invention. The payment screen 940 may be displayed in response to the user 100 selecting the purchase option 840 shown in FIG. 8. FIG. 9 also shows a preview menu 910, which may be used to launch the point-of-purchase media player in the first place and/or displayed during playback of the preview to allow the user 100 to select a different preview for viewing. Additionally, FIG. 9 shows a side pane 920, which may contain third-party content 220, advertisements, or other information on the third-party web site 210.

As shown, the payment screen 940 may be from an online payment processor 214 such as PayPal. The payment screen 940 may receive the login credentials 284 of the user 100, which may have been previously established by the 100 with the online payment processor 214. The payment screen 940 may thus have an e-mail address dialog box 950 and a password dialog box 960 in which the user 100 can enter the login credentials 284.

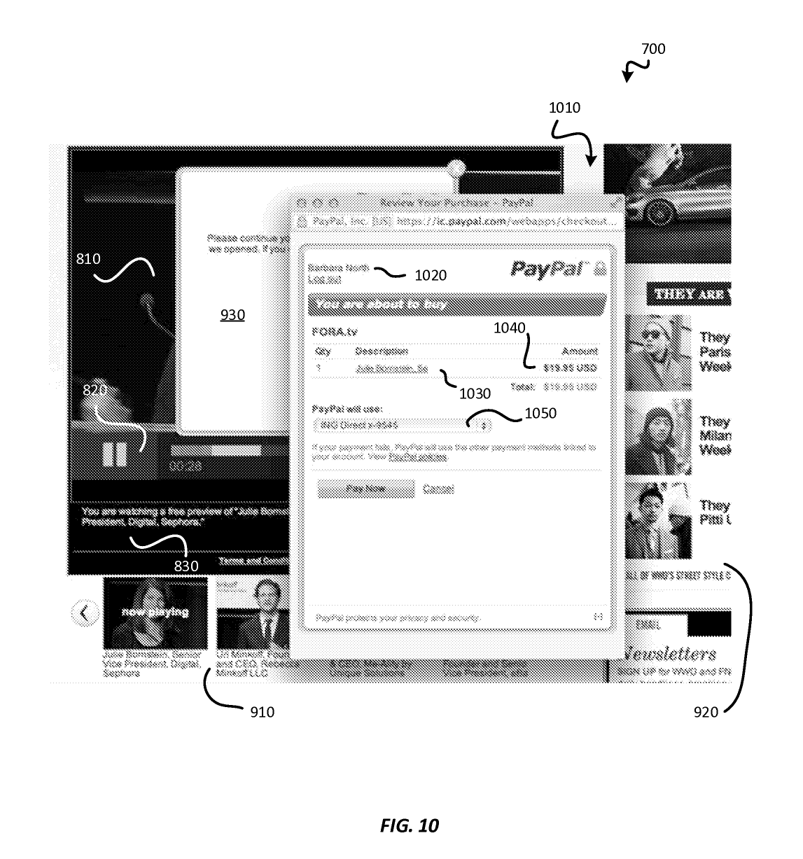

Referring to FIG. 10, a screen shot depicts the point-of-purchase media player 700 of FIG. 7 with a payment confirmation screen 1010 that is displayed after the user 100 completes the payment process initiated in FIG. 9, according to one embodiment of the invention. The payment confirmation screen 1010 may display information regarding the user 100 and/or the transaction that is to be carried out to ensure that all details are correct before the payment finalized. Thus, the payment confirmation screen 1010 may show the name 1020 of the user 100, the identity 1030 of the item(s) to be purchased, the amount 1040 of the payment to be made, and the payment account 1050 to be used for the payment. Other information may be shown and/or verified in the payment confirmation screen 1010.

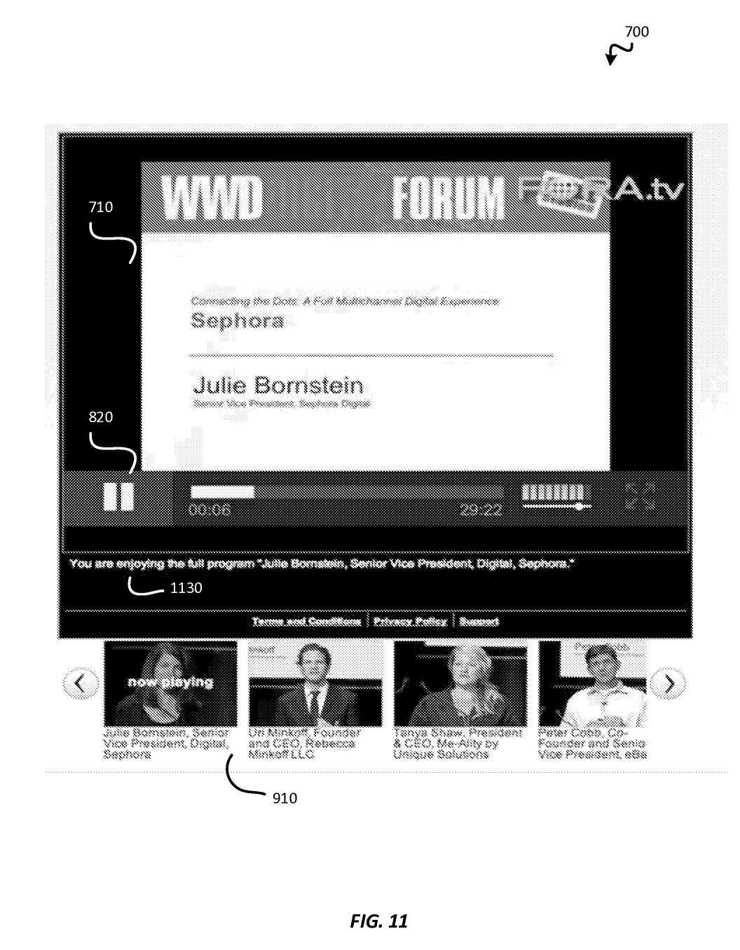

Referring to FIG. 11, a screen shot depicts the point-of-purchase media player 700 of FIG. 7 after completion of the purchase, with the full purchased video available for viewing. Thus, the video pane 710 may play the full video. The point-of-purchase media player 700 may also display the title 1130 of the full video, along with an indicator that it is the full video as opposed to just a preview.

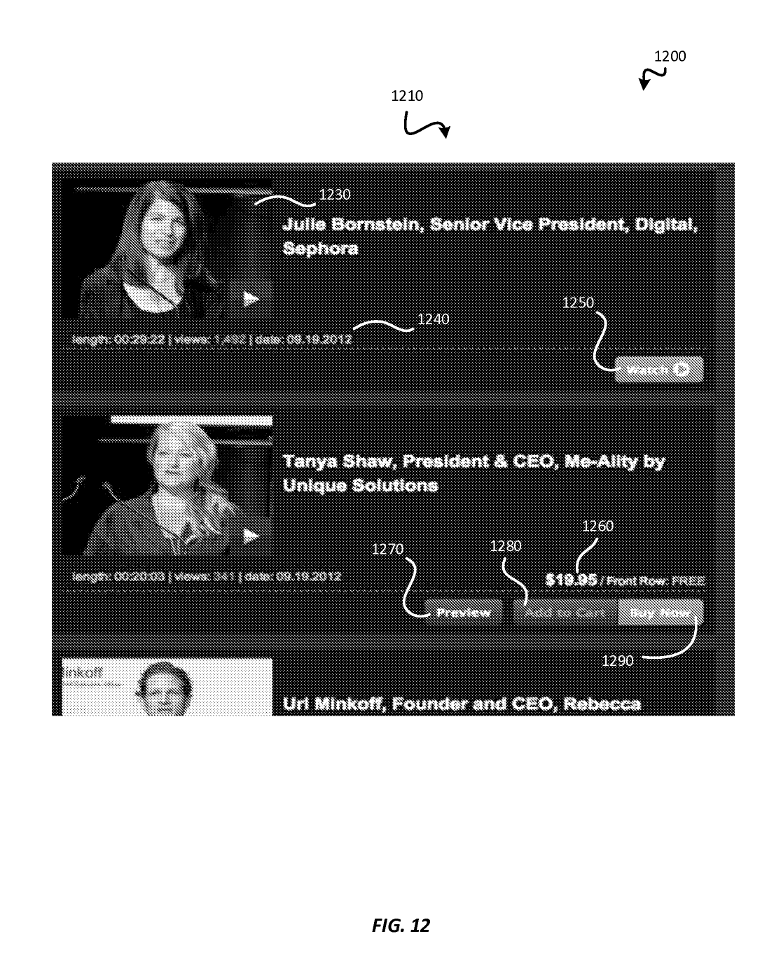

Referring to FIG. 12, a screen shot depicts a portion 1200 of an online retailer web site 279 that makes the video available for viewing after the video has been purchased. The online retailer web site 279 may list several videos that can be viewed, along with indicators as to whether they have been purchased. Viewing a video may entail streaming the video over the Internet and/or downloading the video on a temporary or long-term basis.

More particularly, the portion 1200 may show a video list 1210 with multiple videos shown. Each of the videos in the video list 1210 may have a video pane 1230, which may be activated to play a preview of the corresponding full video like the preview of FIG. 8. Each video may also have metadata 1240 that indicates information such as the date the video was recorded, the number of times it has been viewed, the length of the full video, and the like.

For videos that have been purchased, the portion 1200 may show a “watch” button 1250 that can be selected by the user to view the full video. The online retailer 212 may use the authentication procedures set forth previously to determine, prior to displaying the portion 1200 for the user, that the user 100 is authorized to view the full video.

For videos that have not yet been purchased, the portion 1200 may show a price 1260 for the full video, a “preview” button 1270 that can be selected to initiate playback of the preview, an “add to cart” button 1280 that can be used to facilitate the purchase of multiple items in a multi-step process, and a “buy now” button 1290 to streamline the purchase of a single video without using a shopping cart.

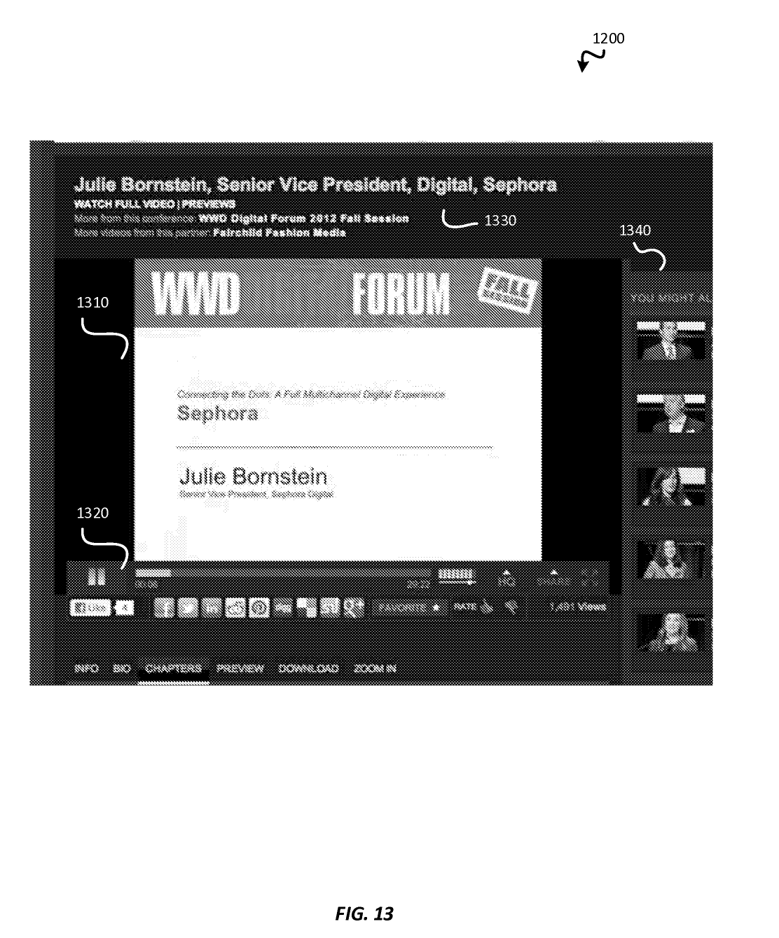

Referring to FIG. 13, a screen shot depicts the portion 1200 of the online retailer web site 279 after a purchased video has been selected for viewing. The full video may be shown in a video pane 1310, which may have a control bar 1320 like that of FIG. 8 to facilitate control of video playback. The portion 1200 may also display a title bar 1330 that provides the title, compilation, and/or other bibliographic information regarding the full video being watched. The portion 1200 may additionally have a preview menu 1340, which may be similar in function to the preview menu 910, but may have a vertical orientation in place of the horizontal orientation of the preview menu 910.

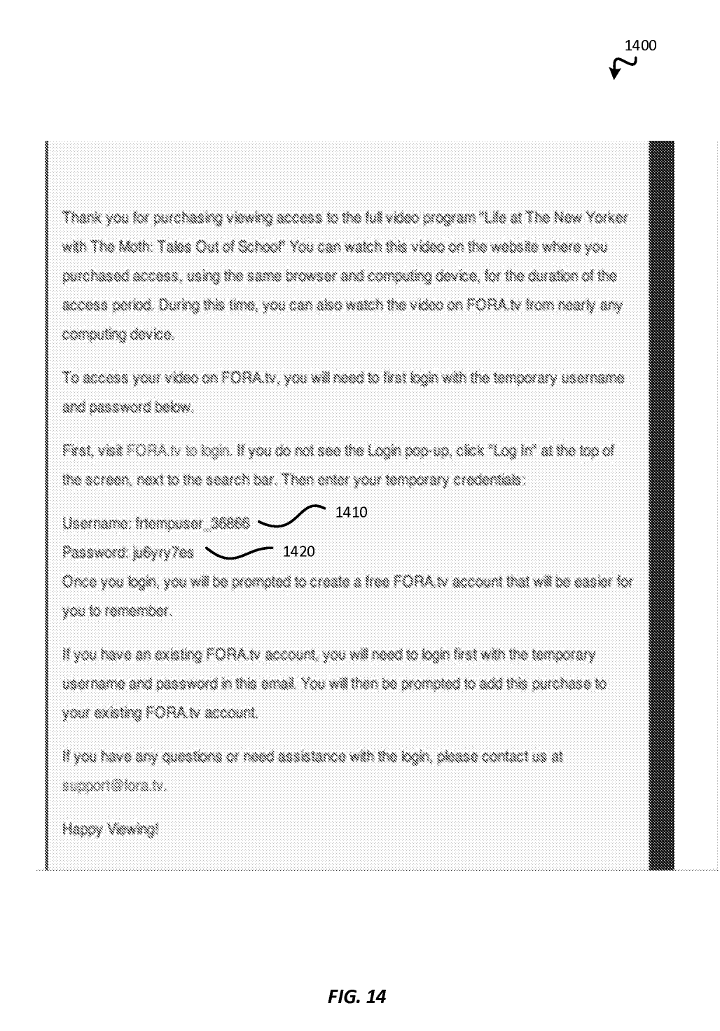

Referring to FIG. 14, a screen shot depicts an e-mail 1400 that may be sent to the user to provide automatically generated login credentials according to one embodiment of the invention. For example, the e-mail 1400 may provide the user with an automatically generated user name 1410 and an automatically generated password 1420. As described previously, the online retailer 212 may receive information from the online payment processor 214 to enable the online retailer 212 to credit the user 100 with the purchase of the item(s). The user name 1410 and the password 1420 may provide access to a new account on the online retailer web site 279 that is authorized to view videos that have been credited to the user 100 in this manner.

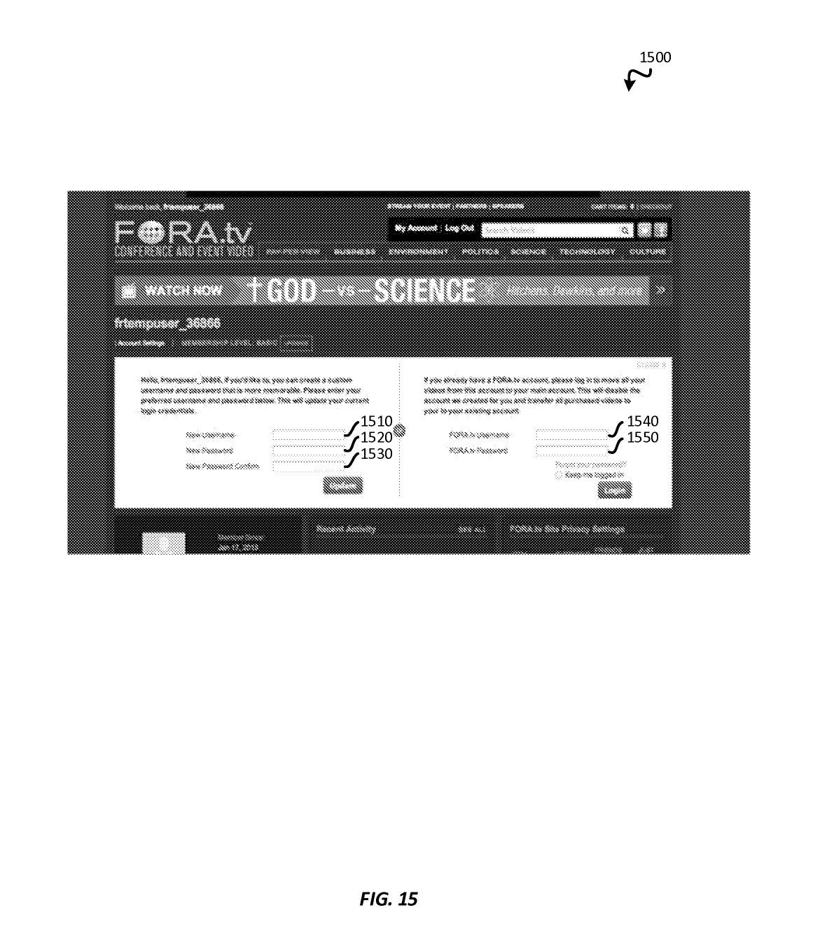

Referring to FIG. 15, a screen shot depicts a login screen 1500 for the online retailer web site 279 according to one embodiment of the invention. The login screen 1500 may be displayed for the user 100 when the user 100 logs into the online retailer web site 279 for the first time. The login screen 1500 may provide the user with the option to provide a new user name 1510 and a new password 1520 (with a confirmation 1530) for the new account. The login screen 1500 may allow the user 100 to, instead, request merger of the new account with a previously-established account by providing his or her user name 1540 and password 1550 under the old account. Providing the user name 1540 and password 1550 may initiate merger of the two accounts under the login credentials of the previously-established account, as described previously.

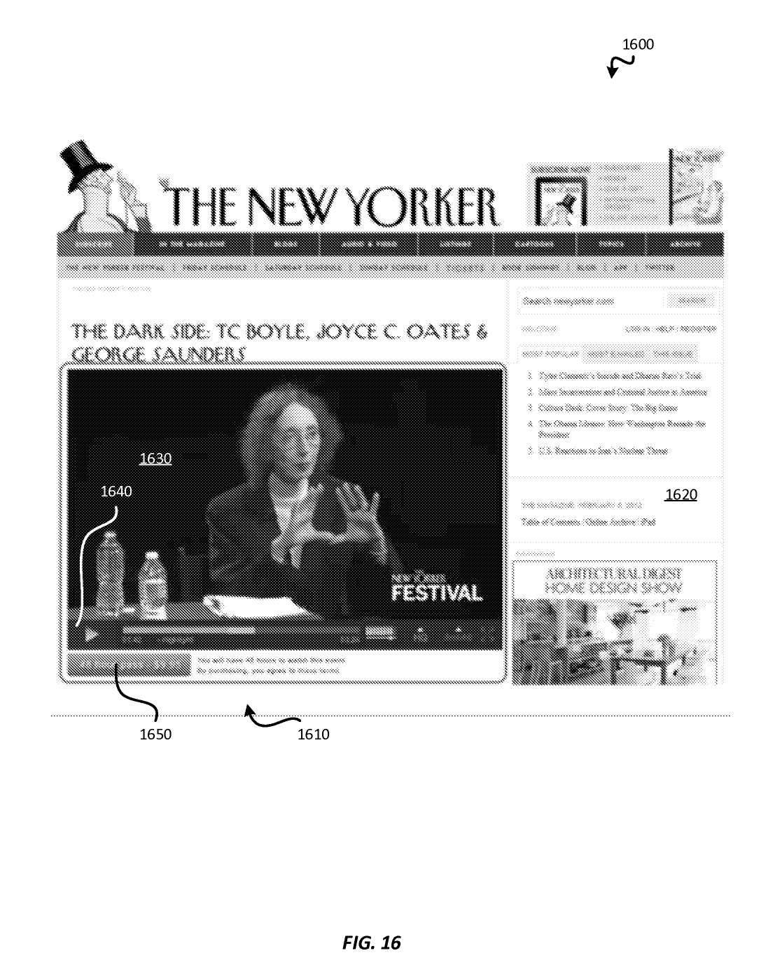

Referring to FIG. 16, a screen shot depicts a third-party web site 1600 with a point-of-purchase media player 1610 embedded according to another embodiment of the invention. The point-of-purchase media player 1610 may be implemented as an iFrame embedded in the third-party web site 1600. The point-of-purchase media player 1610 may be displayed alongside third-party content 1620 of the third-party web site 1600. As shown, the point-of-purchase media player 1610 may have a video pane 1630 that displays a preview of the full video available, a control bar 1640, and a purchase option 1650 that can be selected to initiate purchase of the full video.

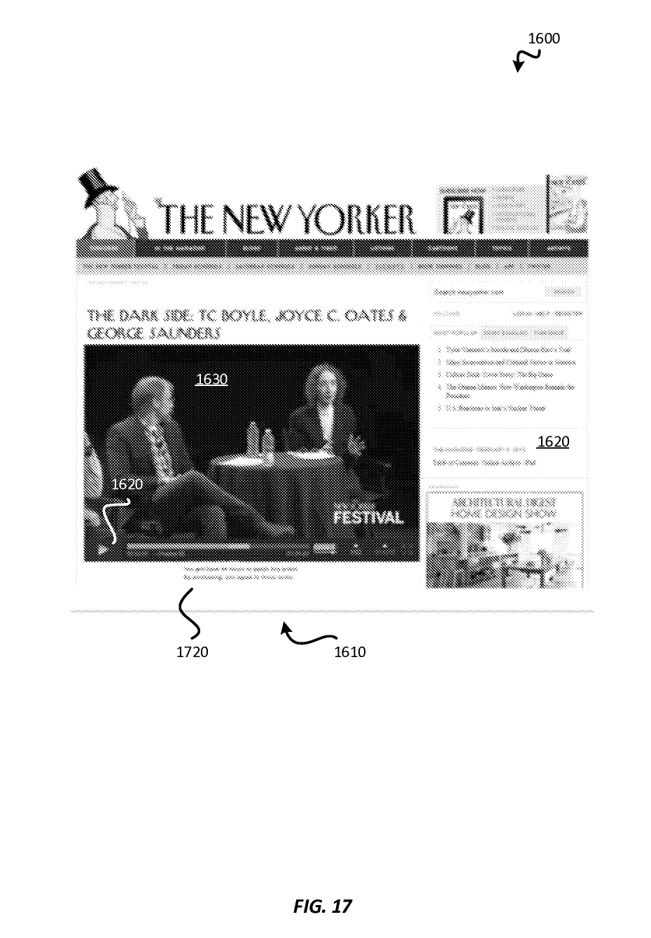

Referring to FIG. 17, a screen shot depicts the third-party web site 1600 with the point-of-purchase media player 1610 of FIG. 16 after a full video has been purchased, according to one embodiment of the invention. As shown, the point-of-purchase media player 1610 may have a status bar 1720 that is displayed below the video pane 1630. The status bar 1720 may provide various information items, such as the duration of the viewing period for the full video, terms and conditions, etc.

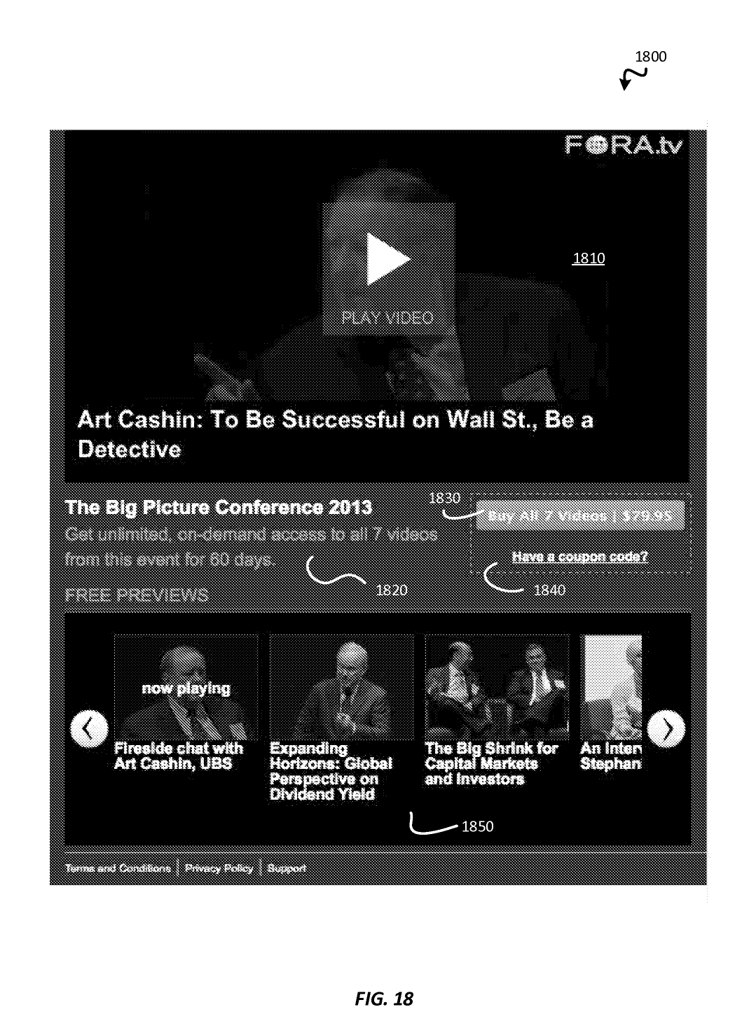

Referring to FIG. 18, a screen shot depicts a point-of-purchase media player 1800 according to another embodiment of the invention. The point-of-purchase media player 1800 may be used to facilitate the purchase of a compilation of videos, such as a collection from a conference or other event.

The point-of-purchase media player 1800 may display a video pane 1810, which may be used to show previews and/or full videos as in previous embodiments. The point-of-purchase media player 1800 may also have a compilation label 1820 indicating the compilation of which the previewed video is a part. A purchase option 1830 may facilitate the purchase of the entire compilation. A coupon link 1840 may be used to enter a coupon or other discount for purchase of a video or compilation. A preview menu 1850 may provide a list of other previews and/or full videos available. The preview menu 1850 may display only other videos from the same compilation, or may display other compilations, if desired.

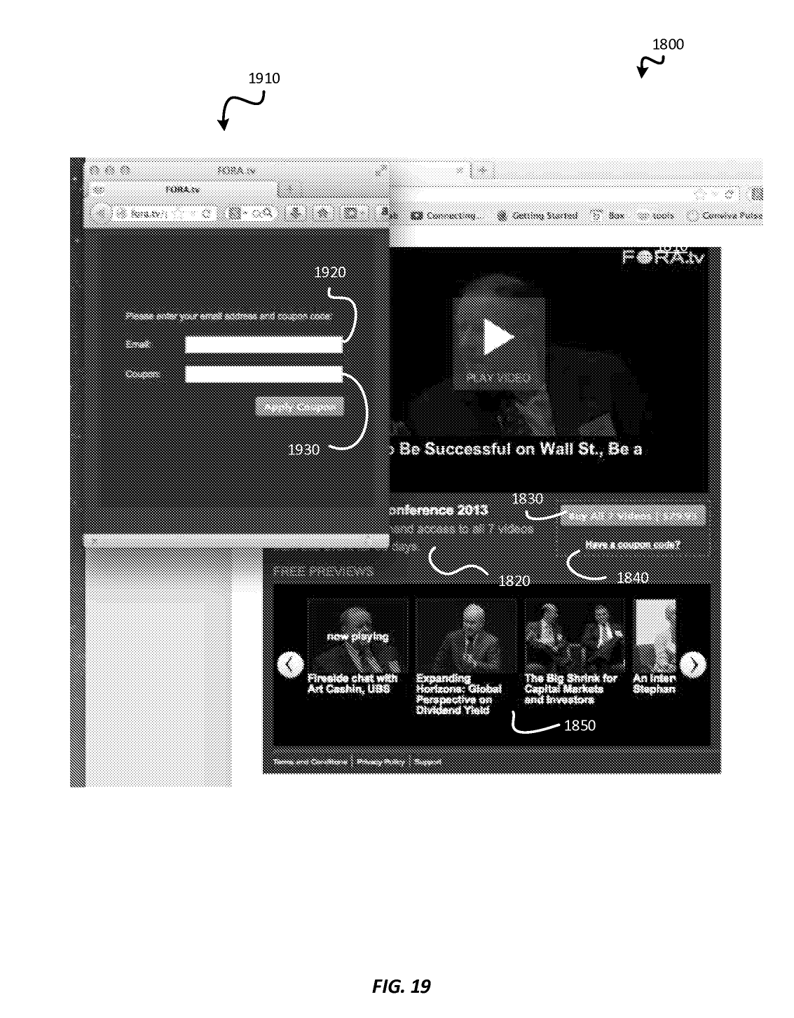

Referring to FIG. 19, a screen shot depicts the point-of-purchase media player 1800 of FIG. 18 after the user has made a selection to enter a coupon, according to one embodiment of the invention. FIG. 19 displays a coupon entry window 1910, which may be displayed in response to selection of the coupon link 1840. The coupon entry window 1910 may have an e-mail address dialog box 1920 and a coupon dialog box 1930. Thus, the user 100 may enter a coupon that was sent to him or her via e-mail or is otherwise connected to his or her account with the online retailer 212. The online retailer 212 can use the e-mail address of the user 100 to ensure that the user 100 is a valid recipient of the coupon before crediting the coupon toward the purchase of the full video.

One skilled in the art will recognize that the examples depicted and described herein are merely illustrative, and that other arrangements of user interface elements can be used. In addition, some of the depicted elements can be omitted or changed, and additional elements depicted, without departing from the essential characteristics of the invention.

The present invention has been described in particular detail with respect to possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment of the invention. The appearances of the phrases “in one embodiment” or “in at least one embodiment” in various places in the specification are not necessarily all referring to the same embodiment.

In various embodiments, the present invention can be implemented as a system or a method for performing the above-described techniques, either singly or in any combination. In another embodiment, the present invention can be implemented as a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware and/or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

Accordingly, in various embodiments, the present invention can be implemented as software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the invention include: a mobile phone, personal digital assistant, smartphone, kiosk, server computer, enterprise computing device, desktop computer, laptop computer, tablet computer, consumer electronic device, or the like. An electronic device for implementing the present invention may use any operating system such as, for example and without limitation: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A computer-implemented method for making purchases, the method comprising:
at a third-party web site, posting content from an online retailer, wherein the content indicates that at least a first item is available for purchase;
displaying, at a display device, the content for a user viewing the third-party web site;
receiving, at an input device, a user selection of the first item from the content, wherein the user selection indicates that the user desires to purchase the first item; and
in response to receipt of the user selection:
initiating payment from the user for the first item, independently of interaction of the user with any web site hosted by the online retailer;
determining whether an account associated with the user exists within an online retailer database; and
responsive to a determination that no account associated with the user exists within the online retailer database:
automatically creating a first account in an online retailer database operated by the online retailer;
automatically generating online retailer login credentials that provide the user with access to the first account; and
responsive to receipt of confirmation of payment from the user for the first item, storing an indication in the first account that the user has purchased the first item.

2. The method of claim 1, further comprising:
responsive to a determination that an account associated with the user exists within the online retailer database, storing an indication in the existing account that the user has purchased the first item.

3. The method of claim 1, wherein posting the content at the third-party web site comprises embedding the content in third-party content of the third-party web site, and wherein displaying the content for the user comprises displaying the content embedded in the third-party content.

4. The method of claim 1, wherein the first item comprises a first digital media segment, wherein the method further comprises:
responsive to receipt of confirmation of payment from the user for the first item, playing the first digital media segment.

5. The method of claim 4, wherein displaying the content for the user comprises playing a preview of the first digital media segment.

6. The method of claim 5, wherein the preview comprises a subset of the first digital media segment.

7. The method of claim 5, wherein the preview comprises content descriptive of the first digital media segment.

8. The method of claim 5, wherein displaying the content for the user further comprises, while playing the preview, displaying a purchase option that can be selected with the input device to provide the user selection.

9. The method of claim 4, wherein the first digital media segment comprises a digital video, wherein posting the content at the third party web site comprises embedding a video player in the third-party web site, wherein playing the first digital media segment comprises playing the digital video with the video player.

10. The method of claim 9, further comprising:
assessing at least one of video playback capability and payment processing capability of at least one of the third-party web site and a content viewing application used by the user; and
customizing the content based on the assessment.

11. The method of claim 9, further comprising:
assessing a degree to which a content viewing application used by the user is compatible with the content; and
customizing the content based on the assessment.

12. The method of claim 9, further comprising, in response to receipt of confirmation of payment, making the first digital media segment available to the user on a web site hosted by the online retailer.

13. The method of claim 4, further comprising, in response to receipt of confirmation of payment, making the first digital media segment available to the user on an application installed on a computing device controlled by the user.

14. The method of claim 4, further comprising:
in response to receipt of confirmation of payment, providing an authorization on a computing device controlled by the user; and
prior to playing the first digital media segment, validating the authorization.

15. The method of claim 14, wherein providing the authorization comprises copying a token to the computing device, wherein validating the authorization comprises validating the token.

16. The method of claim 4, wherein the first item further comprises a second digital media segment such that the first item defines a compilation comprising at least the first digital media segment and the second digital media segment.

17. The method of claim 1, further comprising:
in response to initiation of payment from the user for the first item, processing the payment independently of interaction of the user with a retailer web site operated by the online retailer and connected to the online retailer database; and
in response to processing of the payment, crediting the user, in the online retailer database, with purchase of the first item.

18. The method of claim 17, wherein processing the payment comprises processing the payment via an online payment processor independent of the retailer web site and the third-party web site.

19. The method of claim 18, wherein processing the payment comprises:
obtaining payment login credentials for the user; and
recording the payment in a payment database connected to the online payment processor.

20. The method of claim 19, further comprising transmitting an e-mail to the user, wherein the e-mail contains the retailer login credentials.

21. The method of claim 19, further comprising:
receiving a request from the user to merge the first account with a second account associated with the user in the online retailer database; and
in response to receipt of the request, crediting the second account with purchase of the first item.

22. The method of claim 1, wherein the content further indicates that a second item is available for purchase.

23. The method of claim 1, wherein initiation of payment for the first item occurs independently of navigation away from the third-party web site.

24. A computer program product for making purchases, the computer program product comprising:
a non-transitory computer-readable storage medium; and
computer program code, encoded on the medium, configured to cause at least one processor to perform the steps of:
at a third-party web site, posting content from an online retailer, wherein the content indicates that at least a first item is available for purchase;
causing a display device to display the content for a user viewing the third-party web site;
causing an input device to be receptive to a user selection of the first item from the content, wherein the user selection indicates that the user desires to purchase the first item; and
in response to receipt of the user selection:
initiating payment from the user for the first item, independently of interaction of the user with any web site hosted by the online retailer;
determining whether an account associated with the user exists within an online retailer database; and
responsive to a determination that no account associated with the user exists within the online retailer database:
automatically creating a first account in an online retailer database operated by the online retailer;
automatically generating online retailer login credentials that provide the user with access to the first account; and
responsive to receipt of confirmation of payment from the user for the first item, storing an indication in the first account that the user has purchased the first item.

25. The computer program product of claim 24, wherein the computer program product is further configured to cause the at least one processor to perform the step of:
responsive to a determination that an account associated with the user exists within the online retailer database, storing an indication in the existing account that the user has purchased the first item.

26. The computer program product of claim 24, wherein the computer program code configured to cause the at least one processor to post the content at the third-party web site comprises computer program code configured to cause the at least one processor to embed the content in third-party content of the third-party web site, and wherein the computer program code configured to cause the at least one processor to display the content for the user comprises computer program code configured to cause the at least one processor to display the content embedded in the third-party content.

27. The computer program product of claim 24, wherein the first item comprises a first digital media segment, and wherein the computer program code is further configured to cause the at least one processor to perform the step of:
responsive to receipt of confirmation of payment from the user for the first item, playing the first digital media segment.

28. The computer program product of claim 27, wherein the computer program code configured to cause the at least one processor to display the content for the user comprises computer program code configured to cause the at least one processor to play a preview of the first digital media segment.

29. The computer program product of claim 27, wherein the first digital media segment comprises a digital video, wherein the computer program code configured to cause the at least one processor to post the content at the third party web site comprises computer program code configured to cause the at least one processor to embed a video player in the third-party web site, and wherein the computer program code configured to cause the at least one processor to play the first digital media segment comprises computer program code configured to cause the at least one processor to play the digital video with the video player.

30. The computer program product of claim 29, wherein the computer program code is further configured to cause the at least one processor to perform the step of:
in response to receipt of confirmation of payment, making the first digital media segment available to the user on a web site hosted by the online retailer.

31. The computer program product of claim 27, wherein the computer program code is further configured to cause the at least one processor to perform the steps of:
in response to receipt of confirmation of payment, providing an authorization on a computing device controlled by the user; and
prior to playing the first digital media segment, validating the authorization.

32. The computer program product of claim 24, wherein the computer program code is further configured to cause the at least one processor to perform the steps of:
in response to initiation of payment from the user for the first item, processing the payment independently of interaction of the user with a retailer web site operated by the online retailer and connected to the online retailer database; and
in response to processing of the payment, crediting the user, in the online retailer database, with purchase of the first item.

33. The computer program product of claim 32, wherein the computer program code configured to cause the at least one processor to process the payment comprises computer program code configured to cause an online payment processor to process the payment, wherein the online payment processor is independent of the retailer web site and the third-party web site.

34. The computer program product of claim 33, wherein the computer program code is further configured to cause the at least one processor to perform the steps of:
receiving a request from the user to merge the first account with a second account associated with the user in the online retailer database; and
in response to receipt of the request, crediting the second account with purchase of the first item.

35. The computer program product of claim 24, wherein the computer program code configured to cause the at least one processor to initiate payment for the first item is configured to cause the at least one processor to initiate payment of the first item independently of navigation away from the third-party web site.

36. A system for making purchases, the system comprising:
a processor configured to, at a third-party web site, post content from an online retailer, wherein the content indicates that at least a first item is available for purchase;
a display device, communicatively coupled to the processor, configured to display the content for a user viewing the third-party web site; and
an input device, communicatively coupled to the processor, configured to receive a user selection of the first item from the content, wherein the user selection indicates that the user desires to purchase the first item;
wherein the processor is further configured to, in response to receipt of the user selection:
initiate payment from the user for the first item, independently of interaction of the user with any web site hosted by the online retailer;
determine whether an account associated with the user exists within an online retailer database; and
responsive to a determination that no account associated with the user exists within the online retailer database:
automatically create a first account in an online retailer database operated by the online retailer;
automatically generate online retailer login credentials that provide the user with access to the first account; and
responsive to receipt of confirmation of payment from the user for the first item, store an indication in the first account that the user has purchased the first item.

37. The system of claim 36, wherein the processor is further configured to, responsive to a determination that an account associated with the user exists within the online retailer database, store an indication in the existing account that the user has purchased the first item.

38. The system of claim 36, wherein the processor is further configured to post the content at the third-party web site by embedding the content in third-party content of the third-party web site;
and wherein the display device is further configured to display the content for the user by displaying the content embedded in the third-party content.

39. The system of claim 36, wherein the first item comprises a first digital media segment, wherein the processor is further configured to, responsive to receipt of confirmation of payment from the user for the first item, play the first digital media segment.

40. The system of claim 39, wherein the display device is further configured to display the content for the user by playing a preview of the first digital media segment.

41. The system of claim 39, wherein:
the first digital media segment comprises a digital video;
wherein the processor is further configured to post the content at the third party web site by embedding a video player in the third-party web site;
and wherein the display device is further configured to play the first digital media segment by playing the digital video with the video player.

42. The system of claim 41, wherein the processor is further configured to, in response to receipt of confirmation of payment, make the first digital media segment available to the user on a web site hosted by the online retailer.

43. The system of claim 39, wherein the processor is further configured to:
in response to receipt of confirmation of payment, provide an authorization on a computing device controlled by the user; and
prior to playing the first digital media segment, validate the authorization.

44. The system of claim 36, wherein the processor is further configured to:
in response to initiation of payment from the user for the first item, process the payment independently of interaction of the user with a retailer web site operated by the online retailer and connected to the online retailer database; and
in response to processing of the payment, credit the user, in the online retailer database, with purchase of the first item.

45. The system of claim 44, wherein the processor is further configured to process the payment via an online payment processor independent of the retailer web site and the third-party web site.

46. The system of claim 45, wherein the input device is further configured to receive a request from the user to merge the first account with a second account associated with the user in the online retailer database;
and wherein the processor is further configured to, in response to receipt of the request, credit the second account with purchase of the first item.

47. The system of claim 36, wherein the processor is further configured to initiate payment for the first item independently of navigation away from the third-party web site.
